(19) United States
(12) Patent Application Publication
(10) Pub. No.: US 2015/0149894 A1
(43) Pub. Date: May 28, 2015

(54) ELECTRONIC DEVICE, METHOD AND STORAGE MEDIUM

(71) Applicant: Kabushiki Kaisha Toshiba, Tokyo (JP)

(72) Inventor: Qi Zhang, Nishitama-gun (JP)

(73) Assignee: Kabushiki Kaisha Toshiba, Tokyo (JP)

(21) Appl. No.: 14/257,443

(22) Filed: Apr. 21, 2014

Related U.S. Application Data
(60) Provisional application No. 61/908,931, filed on Nov. 26, 2013.

(51) Int. Cl. G06F 17/24; G06F 3/0482; G06F 3/0484; G06F 17/21

(52) U.S. Cl. CPC G06F 17/24; G06F 17/214; G06F 3/0482; G06F 3/04842
USPC 715/268

(57) ABSTRACT

According to one embodiment, an electronic device includes a display controller. The display controller is configured to display first strokes as selection targets in accordance with a first operation for selecting a first range including the first strokes in a handwritten document. The display controller is configured to display a second range selected by a second operation, if the second operation is performed during displaying the first strokes as the selection targets.

### CROSS-REFERENCE TO RELATED APPLICATIONS

This application claims the benefit of U.S. Provisional Application No. 61/908,931, filed Nov. 26, 2013, the entire contents of which are incorporated herein by reference.

### FIELD

Embodiments described herein relate generally to a technique of selecting a stroke contained in a handwritten document.

### BACKGROUND

Various electronic devices provided with touch screen displays and enabled to perform handwriting input, such as tablets, personal digital assistants (PDAs) and smartphones, have recently been developed.

In these electronic devices, when a document input by handwriting (hereinafter, referred to simply as “a handwritten document”) is edited, only strokes as editing targets are selected from a plurality of strokes contained in the handwritten document by a range selection operation, and are subjected to editing.

However, during the above-mentioned range selection operation, a stroke, which a user does not intend to use as an editing target, may be included in the editing targets. In this case, it is necessary to re-execute the range selection operation to re-select the editing targets from the beginning. This is inconvenient to the user. There is a demand for a new technique capable of eliminating the inconvenience.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an appearance example of an electronic device according to an embodiment.

FIG. 2 illustrates cooperation of the electronic device and an external device.

FIG. 3 illustrates an example of a document handwritten on the touch screen display of the electronic device.

FIG. 4 is a view for explaining time-sequence information stored by the electronic device into a storage medium and corresponding to the handwritten document of FIG. 3.

FIG. 5 is a block diagram showing the system configuration of the electronic device.

FIG. 6 illustrates screen structural elements on the touch screen display of the electronic device.

FIG. 7 illustrates a desktop screen displayed by a handwriting note application program in the electronic device.

FIG. 8 illustrates a note preview screen displayed by the handwriting note application program in the electronic device.

FIG. 9 illustrates a page editing screen displayed by the handwriting note application program in the electronic device.

FIG. 10 illustrates software buttons on the page editing screen displayed by the handwriting note application program in the electronic device.

FIG. 11 is a block diagram showing a functionality configuration example of the handwriting note application program in the electronic device.

FIG. 12 illustrates one or more strokes selected by the handwriting note application program in the electronic device.

FIG. 13 is a view for explaining a selection target change processing example executed by the handwriting note application program in the electronic device.

FIG. 14 is a view for explaining another selection target change processing example executed by the handwriting note application program in the electronic device.

FIG. 15 is a view for explaining yet another selection target change processing example executed by the handwriting note application program in the electronic device.

FIG. 16 is a view for explaining yet another selection target change processing example executed by the handwriting note application program in the electronic device.

FIG. 17 is a view for explaining yet another selection target change processing example executed by the handwriting note application program in the electronic device.

FIG. 18 is a view for explaining a further selection target change processing example executed by the handwriting note application program in the electronic device.

FIG. 19 is a flowchart showing an editing processing procedure example executed by the handwriting note application program in the electronic device.

### DETAILED DESCRIPTION

Various embodiments will be described hereinafter with reference to the accompanying drawings. In general, according to one embodiment, an electronic device includes a display controller. The display controller is configured to display first strokes as selection targets in accordance with a first operation for selecting a first range including the first strokes in a handwritten document. The display controller is configured to display a second range selected by a second operation, if the second operation is performed during displaying the first strokes as the selection targets. The second range includes either one or more strokes in the first strokes to be excluded from the selection targets, or one or more strokes other than the first strokes to be added to the selection targets. A display form of one or more strokes in the selection targets differs from a display form of one or more strokes that are not in the selection targets.

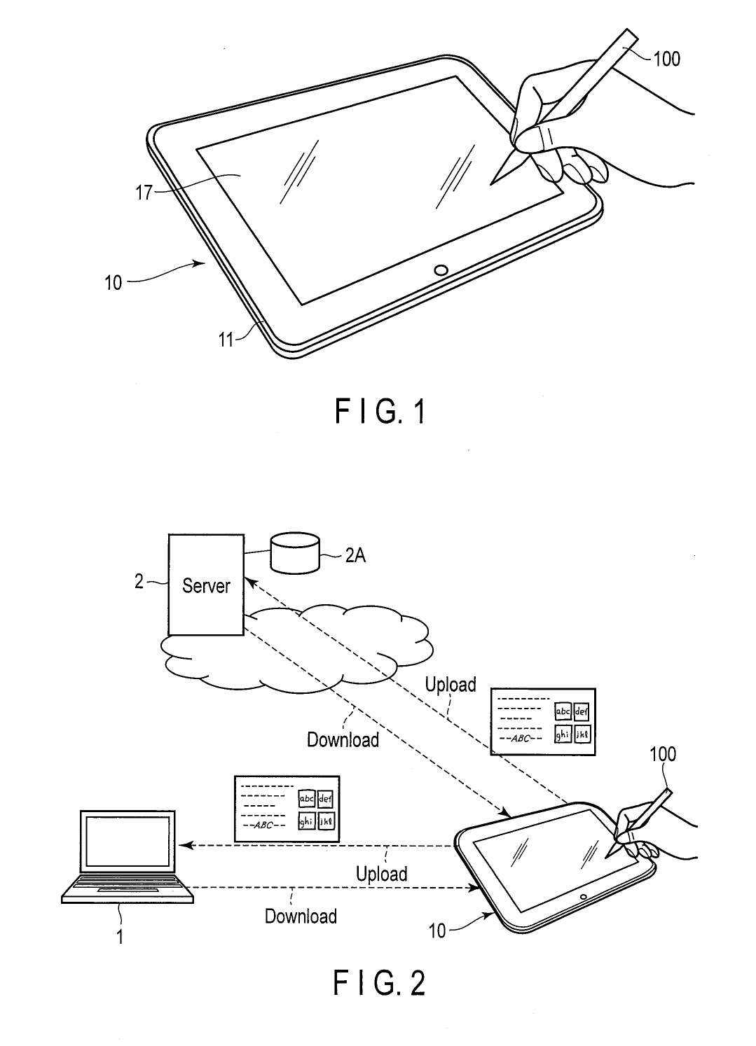

FIG. 1 is a perspective view showing an appearance example of an electronic device according to the embodiment. This electronic device is a stylus-based portable electronic device enabled to perform handwriting input using a stylus or a finger. The electronic device can be realized as a tablet computer, a notebook personal computer, a smartphone, a PDA, etc. In the description below, it is assumed that the electronic device is realized as a tablet computer 10. The tablet computer 10 is also called a tablet or a slate computer, and includes a main unit 11 and a touch screen display 17 as shown in FIG. 1. The touch screen display 17 is attached to the main unit 11, superposed on the upper surface thereof.

The main unit 11 has a thin box-shaped casing. The touch screen display 17 incorporates a flat panel display, and a sensor (sensors) configured to detect the contact position of a stylus or finger on the screen of the flat panel display. The flat panel display may be, for example, a liquid crystal display (LCD). As the sensor, a touch panel of an electrostatic capacitance type, a digitizer of an electromagnetic induction type, etc., can be used. In the description below, it is assumed that both the two sensors, i.e., the digitizer and the touch panel, are incorporated in the touch screen display 17.

The touch screen display 17 can detect not only the touch operation of a finger on the screen, but also the touch operation of a stylus 100 on the screen. The stylus 100 may be, for example, a digitizer stylus (electromagnetic induction stylus). A user can perform a handwriting input operation on the touch screen display 17, using the stylus 100. During the handwriting input operation, the path of the movement of the stylus 100 on the screen, i.e., a handwritten stroke (the path of the handwritten stroke) by the handwriting input operation, is drawn in a real-time manner, whereby a plurality of strokes input by handwriting are displayed on the screen. The path of the movement of the stylus 100 made when the stylus 100 is kept in contact with the screen corresponds to one stroke. A large number of strokes corresponding to handwritten characters, figures, tables, etc., constitute a handwritten document.

In the embodiment, the handwritten document is stored in a storage medium not as image data, but as time-sequence information (handwritten document data) indicating coordinate strings corresponding to the paths of strokes and the order of the strokes. The time-sequence information will be described later in detail. The time-sequence information indicates the order of handwriting of the strokes, and includes a plurality of stroke data items corresponding to the strokes. In other words, the time-sequence information means a set of time-sequence stroke data items corresponding to the strokes. The stroke data items correspond to the respective strokes, and each contain a coordinate data sequence (time-sequence coordinates) corresponding to the points on the path of each stroke. The order of stroke data items corresponds to the order of handwriting of the strokes.

The tablet computer 10 can read arbitrary time-sequence information from the storage medium, and display, on the screen, the handwritten document corresponding to the time-sequence information, i.e., the strokes indicated by the time-sequence information. The strokes indicated by the time-sequence information correspond to the strokes input by handwriting.

The tablet computer 10 of the embodiment also has a touch input mode for enabling a handwriting input operation using a finger instead of the stylus 100. When the touch input mode is operative, the user can perform a handwriting input operation on the touch screen display 17, using a finger. During the handwriting input operation, the path of the movement of the finger on the screen, i.e., a stroke(s) (the path(s) of the handwritten stroke(s)) handwritten by the handwriting input operation, is drawn in a real-time manner. As a result, a plurality of strokes input by handwriting are displayed on the screen.

The tablet computer 10 further has an editing function. The editing function enables the user to perform an editing operation using an “erasure” tool, a range selection tool or any other tool, thereby deleting or shifting an arbitrary handwritten portion (a handwritten character, a handwritten mark, a handwritten figure, a handwritten table, etc.) selected via the range selection tool. Further, the arbitrary handwritten portion of a handwritten document selected by the range selection tool can be designated as a search key for searching a certain handwritten document. Yet further, recognition processing, such as handwritten character recognition/handwritten figure recognition/handwritten table recognition, can be executed on the arbitrary handwritten portion of a handwritten document selected by the range selection tool.

In the embodiment, a handwritten document can be managed as one page or a plurality of pages. In this case, by dividing the time-sequence information (handwritten document data) into portions having an area less than that of the screen, a unit of time-sequence information falling within the screen may be recorded as one page. Alternatively, page size may be set variable. In this case, the size of a page can be set greater than that of the screen, and hence a handwritten document of a size greater than the screen can be treated as one page. If the entire page cannot be displayed on the display at a time, it may be contracted, or be scrolled vertically when it is viewed.

FIG. 2 shows a cooperation example of the tablet computer 10 and an external device. The tablet computer 10 can work together with a personal computer 1 or a cloud. Namely, the tablet computer 10 incorporates a wireless communication device, such as a wireless LAN, and can communicate with the personal computer 1 by radio. The tablet computer 10 can also communicate with a server 2 on the Internet. The server 2 may be a server that provides an online storage service and other various cloud computing services.

The personal computer 1 incorporates a storage device, such as a hard disk drive (HDD). The tablet computer 10 can send time-sequence information (handwritten document data) to the personal computer 1 via the network to record it in the HDD of the personal computer 1 (upload). To secure communication between the tablet computer 10 and the personal computer 1, the personal computer 1 may certify the tablet computer 10 at the start of communication. In this case, a dialog for encouraging the user to input ID or a password may be displayed on the screen of the tablet computer 10. Alternatively, the ID, for example, of the tablet computer 10 may be automatically sent from the tablet computer 10 to the personal computer 1.

As a result, even when the capacity of the storage of the tablet computer 10 is small, the tablet computer 10 can process a large number of time-sequence information items or time-sequence information of a great capacity.

Further, the tablet computer 10 can read one or more arbitrary time-sequence information items from the HDD of the personal computer 1 (download), and display, on the display 17 thereof, the stroke indicated by the read time-sequence information. In this case, a list of thumbnails obtained by contracting the pages of time-sequence information items may be displayed on the screen of the display 17, or one page selected from these thumbnails be displayed with a normal size on the screen of the display 17.

Yet further, the tablet computer 10 may communicate, instead of the personal computer 1, with the server 2 on the cloud that provides, for example, a storage service as mentioned above. The tablet computer 10 can send time-sequence information (handwritten document data) to the server 2 via the network to record it in a storage device 2A incorporated in the server 2 (upload). Further, the tablet computer 10 can read arbitrary time-sequence information from the storage device 2A of the server 2 (download), and display, on the display 17 thereof, the paths of the strokes indicated by the read time-sequence information.

As described above, in the embodiment, the storage medium storing time-sequence information may be any one of the storage device in the tablet computer 10, the storage device in the personal computer 1, and the storage device 2A in the server 2.

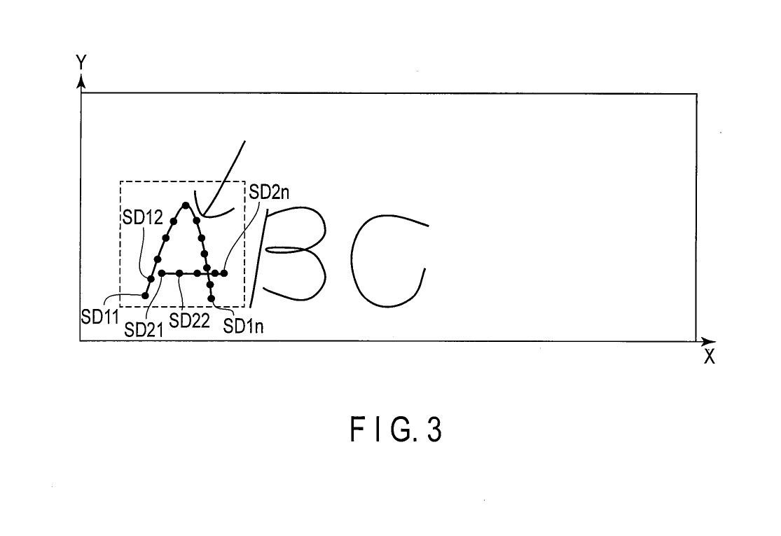

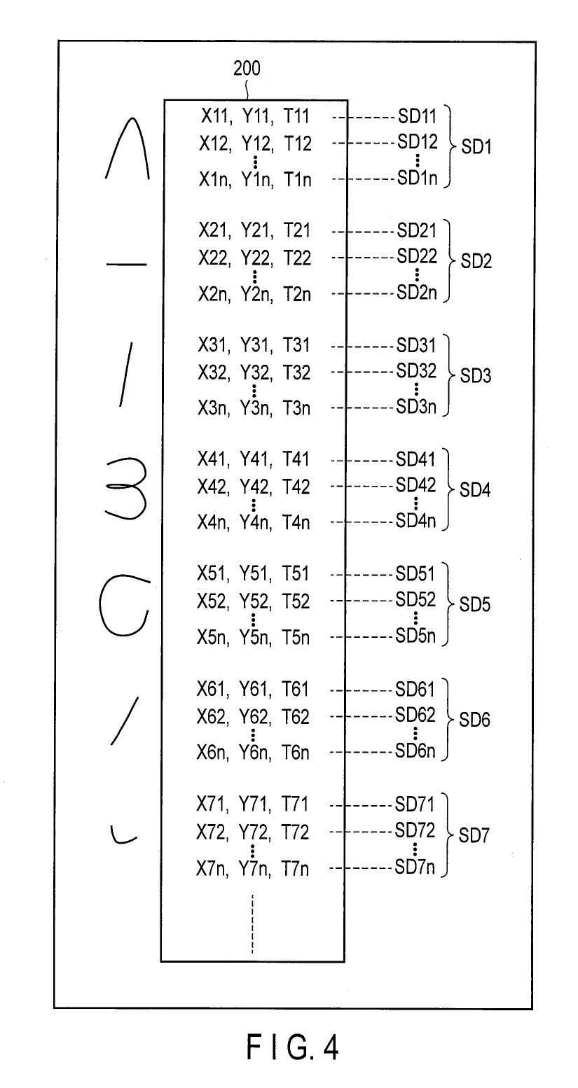

Referring then to FIGS. 3 and 4, a description will be given of the relationship between the stroke (a character, a figure, a table, etc.) handwritten by the user and time-sequence information. FIG. 3 shows an example of a document (handwritten character string) handwritten on the touch screen display 17 using the stylus 100.

In a handwritten document, a character or figure may often be overwritten by handwriting on another character or figure previously input by handwriting. In the case of FIG. 3, it is assumed that a character string of “ABC” was input by handwriting in the order of “A,” “B” and “C,” and thereafter, a handwritten arrow was added near the handwritten character “A” by handwriting input.

The handwritten character “A” is expressed using two strokes handwritten using, for example, the stylus 100 (the path with a shape of “ [symbol] ” and the path with a shape of “-”), i.e., two paths. The path of the stylus 100 firstly handwritten and having the shape of “ [symbol] ” is sampled at, for example, regular intervals in a real-time manner, whereby time-sequence coordinates SD11, SD12, . . . , SD1n corresponding to the stroke with the shape of “ [symbol] ” are obtained. Similarly, the path of the stylus 100 subsequently handwritten and having the shape of “-” is sampled at regular intervals in a real-time manner, whereby time-sequence coordinates SD21, SD22, . . . , SD2n corresponding to the stroke with the shape of “-” are obtained.

The handwritten character “B” is expressed using two strokes handwritten using, for example, the stylus 100, i.e., two paths. The handwritten character “C” is expressed using one stroke handwritten using, for example, the stylus 100, i.e., one path. The handwritten “arrow” is expressed using two strokes handwritten using, for example, the stylus 100, i.e., two paths.

FIG. 4 shows time-sequence information 200 corresponding to the handwritten document of FIG. 3. This time-sequence information includes a plurality of stroke data items SD1, SD2, . . . , SD7. In the time-sequence information 200, the stroke data items SD1, SD2, . . . , SD7 are arranged sequentially in accordance with the sequentially handwritten strokes.

In the time-sequence information 200, the leading two stroke data items SD1 and SD2 indicate the respective two strokes of the handwritten character “A.” The third and fourth stroke data items SD3 and SD4 indicate the two strokes constituting the handwritten character “B.” The fifth stroke data item SD5 indicates the one stroke constituting the handwritten character “C.” The sixth and seventh stroke data items SD6 and SD7 indicate the two strokes constituting the handwritten “arrow.”

Each stroke data item includes a coordinate data sequence (time-sequence coordinates) corresponding to one stroke, i.e., pairs of coordinates corresponding to respective points on the path of the stroke. In each stroke data item, the pairs of coordinates are arranged in a time-sequence manner in which the points of the stroke have been written. For instance, regarding the handwritten character “A,” the stroke data item SD1 includes a coordinate data sequence (time-sequence coordinates) corresponding to respective points on the path of a stroke of “ [symbol] ” in the handwritten character “A,” i.e., n coordinate data items SD11, SD12, . . . , SD1n. The stroke data item SD2 includes a coordinate data sequence (time-sequence coordinates) corresponding to respective points on the path of a stroke of “-” in the handwritten character “A,” i.e., n coordinate data items SD21, SD22, . . . , SD2n. The number of coordinate data items may vary between different stroke data items.

Each coordinate data item indicates an X coordinate and a Y coordinate corresponding to a certain point on a certain path. For instance, the coordinate data SD11 indicates the X coordinate (X11) and the Y coordinate (Y11) of the start point of the stroke of “ [symbol] .” The coordinate data SD1n indicates the X coordinate (X11) and the Y coordinate (Y11) of the end point of the stroke of “ [symbol] .”

Further, each coordinate data item may include timestamp information T indicating the time point at which the point corresponding to the coordinates has been handwritten. This time point may be either an absolute time (e.g., year, month, date, time), or a relative time associated with a certain time point. For example, an absolute time (e.g., year, month, date, time), at which writing of the corresponding stroke has been started, may be added as timestamp information to each stroke data item, and a relative time indicating the difference from the absolute time may be added as timestamp information T to each coordinate data item in each stroke data item.

By thus using time sequence information obtained by adding the timestamp information T to each coordinate data item, the temporal relationship between strokes can be expressed more accurately.

In addition, each coordinate data item may additionally include information (Z) indicating stylus pressure.

The time-sequence information 200 having such a structure as shown in FIG. 4 can express not only the paths of individual strokes, but also the temporal relationship between the strokes. Thus, the time-sequence information 200 enables the handwritten character “A” to be treated as a character or a figure different from the tip of the handwritten “arrow,” even when the tip of the handwritten “arrow” has been handwritten overlapping with or close to the handwritten character “A” as shown in FIG. 3.

Yet further, in the embodiment, as described above, handwritten-document data is not stored as an image or a character recognition result, but is stored as the time-sequence information 200 constituted of a set of time-sequence stroke data items. Accordingly, handwritten characters can be treated regardless of the language of the characters. This means that the structure of the time-sequence information 200 is applicable in common in various countries in the world where different languages are used.

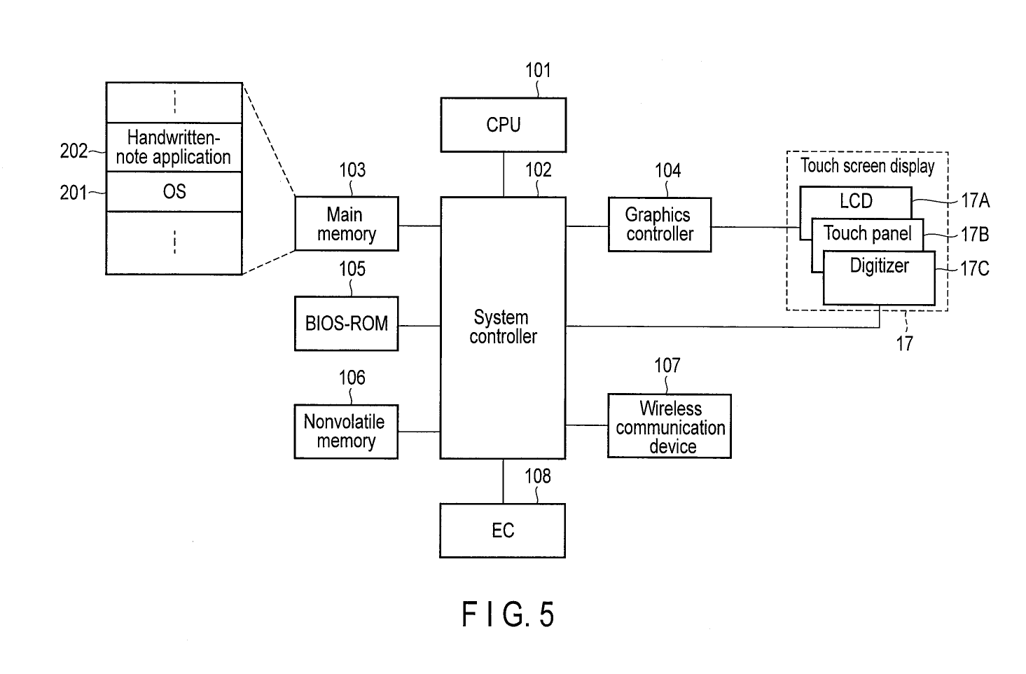

FIG. 5 shows the system configuration of the tablet computer 10.

As shown in FIG. 5, the tablet computer 10 includes a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor for controlling the operations of various modules in the tablet computer 10. The CPU 101 executes various types of software loaded from the nonvolatile memory 106 as a storage device to the main memory 103. The software includes an operating system (OS) 201 and various application programs. The application programs include a handwritten-note application program 202. The handwritten-note application program 202 has a function of creating and displaying the above-mentioned handwritten document data, a function of editing the handwritten document data, and a handwritten-document search function of searching for handwritten document data including a desired handwritten portion, or for the desired handwritten portion in the handwritten document data.

The CPU 101 also executes a basic input/output system (BIOS) stored in the BIOS-ROM 105. The BIOS is a program for controlling hardware.

The system controller 102 is a device for connecting the local bus of the CPU 101 to various components. The system controller 102 contains a memory controller for controlling access to the main memory 103. The system controller 102 also has a function of communicating with the graphics controller 104 via, for example, a serial bus of the PCI EXPRESS standard.

The graphics controller 104 is a display controller for controlling an LCD 17A used as the display monitor of the tablet computer 10. The display signals generated by the graphics controller 104 are sent to the LCD 17A. Based on the display signals, the LCD 17A displays screen images. A tough panel 17B, the LCD 17A and a digitizer 17C are superposed on each other. The touch panel 17B is a pointing device of an electrostatic capacitance type configured to perform inputting on the screen of the LCD 17A. The contact position of a finger on the screen, the movement of the contact position of the finger on the screen, and the like, are detected by the touch panel 17B. The digitizer 17C is a pointing device of an electromagnetic induction type configured to perform inputting on the screen of the LCD 17A. The contact position of a stylus (digitizer stylus) 100 on the screen, the movement of the contact position of the stylus on the screen, and the like, are detected by the digitizer 17C.

The wireless communication device 107 is configured to execute wireless communication, such as a wireless LAN or 3G mobile communication. The EC 108 is a one-chip microcomputer including an embedded controller for power management. The EC 108 has a function of turning on and off the tablet computer 10 in accordance with a user's operation of a power button.

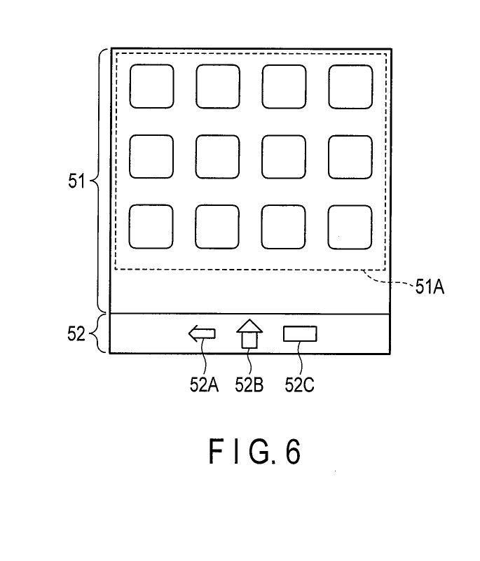

FIG. 6 shows screen elements displayed on the touch screen display 17.

The screen includes a display region (also referred to as a content region) 51, and a bar (also referred to as a navigation bar) 52 below the display region 51. The display region 51 is used to display content. The content of an application program in an active state is displayed on the display region 51. In FIG. 6, it is assumed that a launcher program is in the active state. In this case, a plurality of icons 51A corresponding to a plurality of application programs are displayed on the display region 51 by the launcher program.

The state in which a certain application program is in the active state means that this application program has been shifted to a foreground, namely, that the application program has been activated and focused.

The bar 52 is a region for displaying one or more software buttons of OS 201 (also called software keys). Predetermined functions are assigned to the respective software buttons. When a certain software button has been tapped by a finger or the stylus 100, the function assigned to the software button is executed by the OS 201. For instance, in the environment of Android (registered trademark), a return button 52A, a home button 52B and a recent application button 52C are displayed on the bar 52 as shown in FIG. 6. These software buttons are displayed on the default display portions of the bar 52.

A description will now be given of typical screen examples presented to a user by the handwritten-note application program 202.

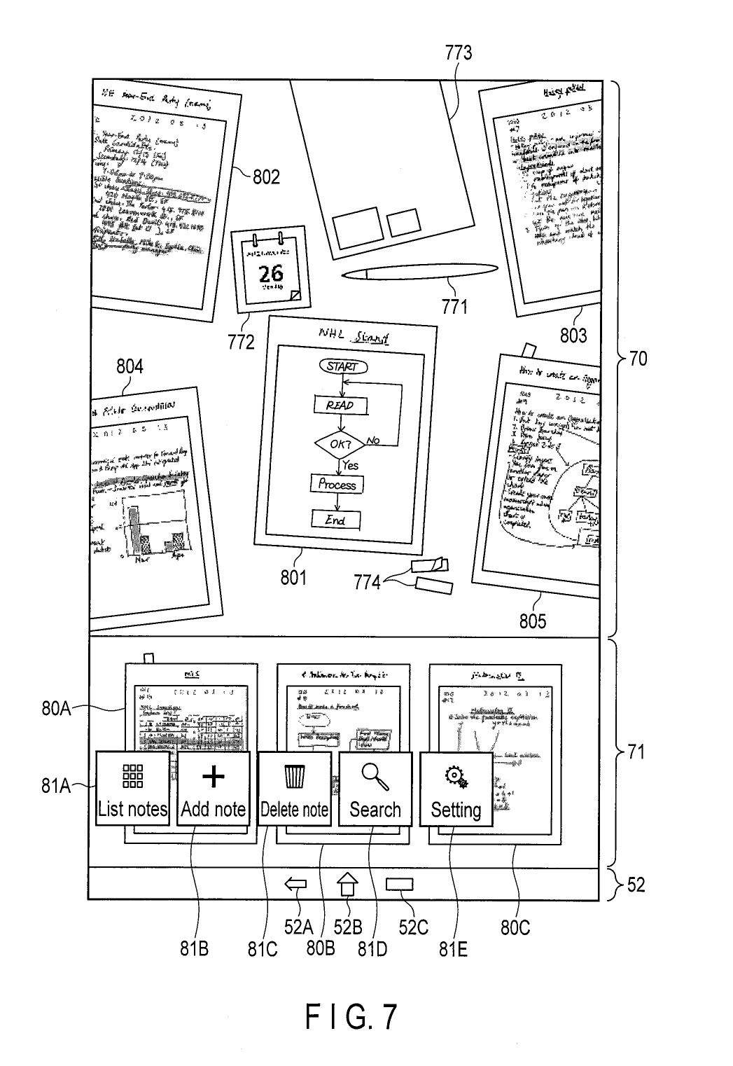

FIG. 7 shows a desktop screen displayed by the handwritten-note application program 202. The desktop screen is a basic screen for handling a plurality of handwritten document data items. The handwritten document data will hereinafter be referred to as “a handwritten note.”

The desktop screen includes a desktop screen region 70 and a drawer screen region 71. The desktop screen region 70 is a temporary region for displaying a plurality of note icons 801 to 805 corresponding to a plurality of handwritten notes currently being operated. The note icons 801 to 805 display respective thumbnails on certain pages in handwritten notes corresponding to the icons. The desktop screen region 70 further displays a stylus icon 771, a calendar icon 772, a scrap note (gallery) icon 773 and tag (label) icons 774.

The stylus icon 771 is a graphical user interface (GUI) for switching the display screen from the desktop screen to a page editing screen. The calendar icon 772 indicates the current date. The scrap note icon 773 is a GUI for browsing data (called scrap data or gallery data) fetched from another application program or an external file. The tag icons 774 are GUIs for attaching labels (tags) to arbitrary pages in an arbitrary handwritten note.

The drawer screen region 71 is a display region for browsing a storage region for storing all created handwritten notes. The drawer screen region 71 displays note icons 80A, 80B and 80C corresponding to some of the created handwritten notes. The note icons 80A, 80B and 80C display thumbnails on certain pages of the respective handwritten notes. The handwritten-note application program 202 can detect a gesture (e.g., a swipe gesture) made on the drawer screen region 71 using the stylus 100 or a finger. In response to detection of the gesture (e.g., the swipe gesture), the handwritten-note application program 202 leftward or rightward scrolls a screen image on the drawer screen region 71. As a result, note icons corresponding to arbitrary handwritten notes are displayed on the drawer screen region 71.

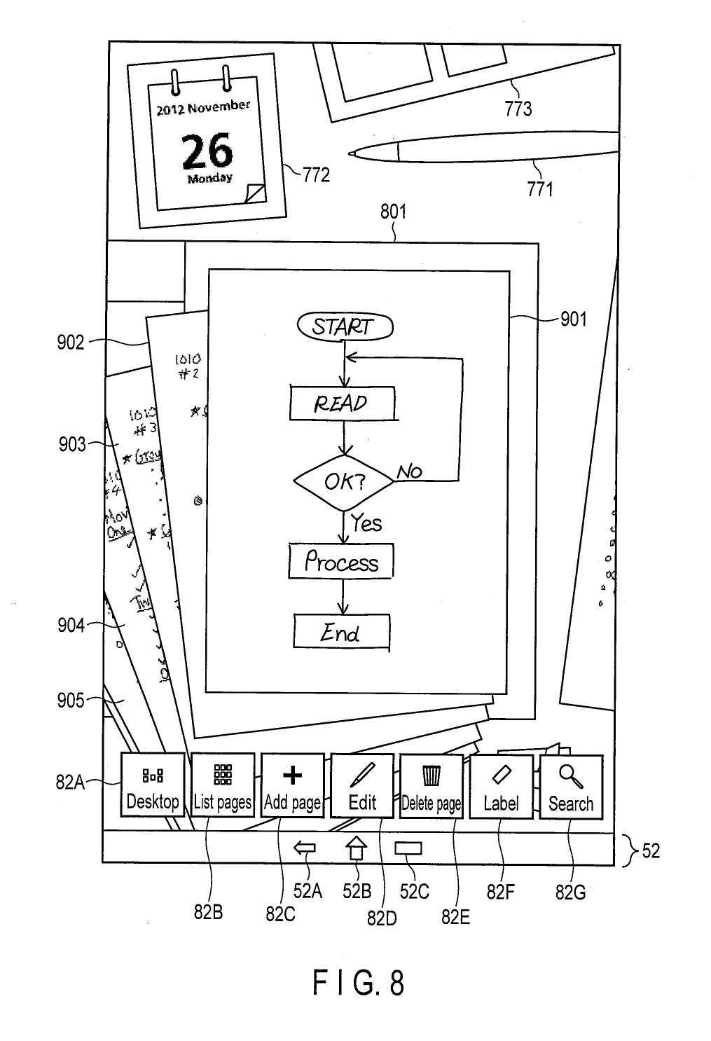

The handwritten-note application program 202 can also detect a gesture (e.g., a tap gesture) made on each note icon of the drawer screen region 71 using the stylus 100 or a finger. In response to detection of the gesture (e.g., the tap gesture) on a certain note icon of the drawing screen region 71, the handwritten-note application program 202 shifts the note icon to the center of the desktop screen region 70. After that, the handwritten-note application program 202 selects the handwritten note corresponding to this note icon, and displays the note preview screen shown in FIG. 8, instead of the desktop screen. The note preview screen of FIG. 8 permits browsing of an arbitrary page in the selected handwritten note.

The handwritten-note application program 202 can further detect a gesture (e.g., a tap gesture) made on the desktop screen region 70 using the stylus 100 or a finger. In response to detection of the gesture (e.g., the tap gesture) on a certain note icon positioned at the center of the desktop screen region 70, the handwritten-note application program 202 selects the handwritten note corresponding to the note icon positioned at the center, and displays the note preview screen shown in FIG. 8, instead of the desktop screen.

The desktop screen can also display a menu. This menu includes a list note button 81A, a note adding button 81B, a note deleting button 81C, a search button 81D and a setting button 81E. The list note button 81A is used to display a list of handwritten notes. The note adding button 81B is used to create (add) a new handwritten note. The note deleting button 81C is used to delete a handwritten note. The search button 81D is used to open a search screen (search dialog). The setting button 81E is used to open a setting screen.

The bar 52 displays the return button 52A, the home button 52B and the recent application button 52C.

FIG. 8 shows the above-mentioned note preview screen.

The note preview screen permits browsing of an arbitrary page in the selected handwritten note. It is assumed here that a handwritten note corresponding to the note icon 801 has been selected. In this case, the handwritten-note application program 202 displays a plurality of pages 901, 902, 903, 904 and 905 included in the handwritten note, so that at least parts of the pages 901, 902, 903, 904 and 905 will be visible and overlap each other.

The note preview screen further displays the above-mentioned stylus icon 771, the calendar icon 772, the scrap note icon 773 and the tag icons 774.

The note preview screen can further display a menu. This menu includes a desktop button 82A, a list page button 82B, a page adding button 82C, an editing button 82D, a page deleting button 82E, a label button 82F and a search button 82G. The desktop button 82A is used to display the desktop screen. The list page button 82B is used to display a list of pages in a currently selected handwritten note. The page adding button 82C is used to create (add) a new page. The editing button 82D is used to display a page editing screen. The page deleting button 82E is used to delete a page. The label button 82F is used to display a list of usable label types. The search button 82G is used to display a search screen.

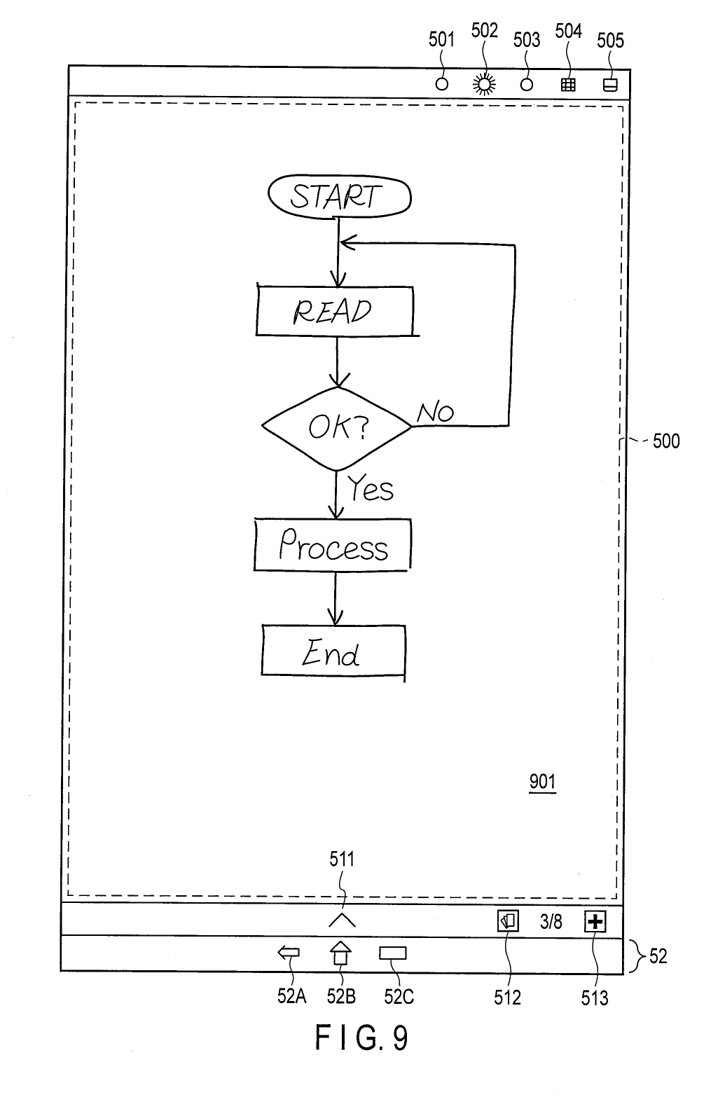

The handwritten-note application program 202 can detect various gestures made by the user on the note preview screen. For instance, in response to detection of a certain gesture, the handwritten-note application program 202 changes (page feed, page return), to a desired page, the page to be displayed at the uppermost portion. Further, in response to detection of a certain gesture (e.g., a tap gesture) made on the uppermost page, or in response to detection of a certain gesture (e.g., a tap gesture) made on the stylus icon 771, or in response to detection of a certain gesture (e.g., a tap gesture) made on the editing button 82D, the handwritten-note application program 202 selects the uppermost page, and displays the page editing screen shown in FIG. 9, instead of the note preview screen.

The page editing screen of FIG. 9 permits generation of a new page (handwritten page), and browsing and editing of an existing page. If a page 901 on the note preview screen of FIG. 8 has been selected, the page editing screen displays the content of the page 901 as shown in FIG. 9.

On the page editing screen, a rectangular region 500 enclosed by the broken line is a handwriting input region in which handwriting input is possible. In the handwriting input region 500, an event input through the digitizer 17C is used for display (drawing) of a handwritten stroke, and is not used as an event indicating a gesture, such as a tap. In contrast, on the page editing screen, in the region other than the handwriting input region 500, the event input through the digitizer 17C is also usable as an event indicating a gesture, such as a tap gesture.

An input event from the touch panel 17B is not used to display (draw) a handwritten stroke, but is used as an event indicating a gesture, such as a tap gesture and a swipe gesture.

The page editing screen also displays a quick select menu that includes three styluses 501 to 503 beforehand registered by the user, a range selection stylus 504 and an eraser rubber stylus 505. In this embodiment, it is assumed that a black stylus 501, a red stylus 502 and a marker 503 are beforehand registered by the user. By tapping a certain stylus (button) in the quick select menu, using the stylus 100 or a finger, the user can switch the type of stylus used. For instance, if a handwriting input operation has been performed on the page editing screen using the stylus 100, with the black stylus 501 selected by a user's tap gesture using the stylus 100 or a finger, the handwritten-note application program 202 displays a black stroke (path) on the page editing screen in accordance with the motion of the stylus 100. Further, if a handwriting input operation has been performed on the page editing screen using the stylus 100, with the range selection stylus 504 selected by a user's tap gesture using the stylus 100 or a finger, the handwritten-note application program 202 displays a frame of a rectangular or circular shape or of an arbitrary shape corresponding to the motion of the stylus 100. In the embodiment, a description will be given, assuming that when a handwriting input operation has been performed with the range selection stylus 504 selected, a rectangular frame is displayed on the page editing screen.

The above-mentioned three types of styluses in the quick select menu can be also switched by operating a side button attached to the stylus 100. A combination of a frequently used color, a thickness (width), etc. can be set for each of the above-mentioned three types of styluses.

The page editing screen also displays a menu button 511, a page return button 512 and a page feed button 513. The menu button 511 is used to display a menu.

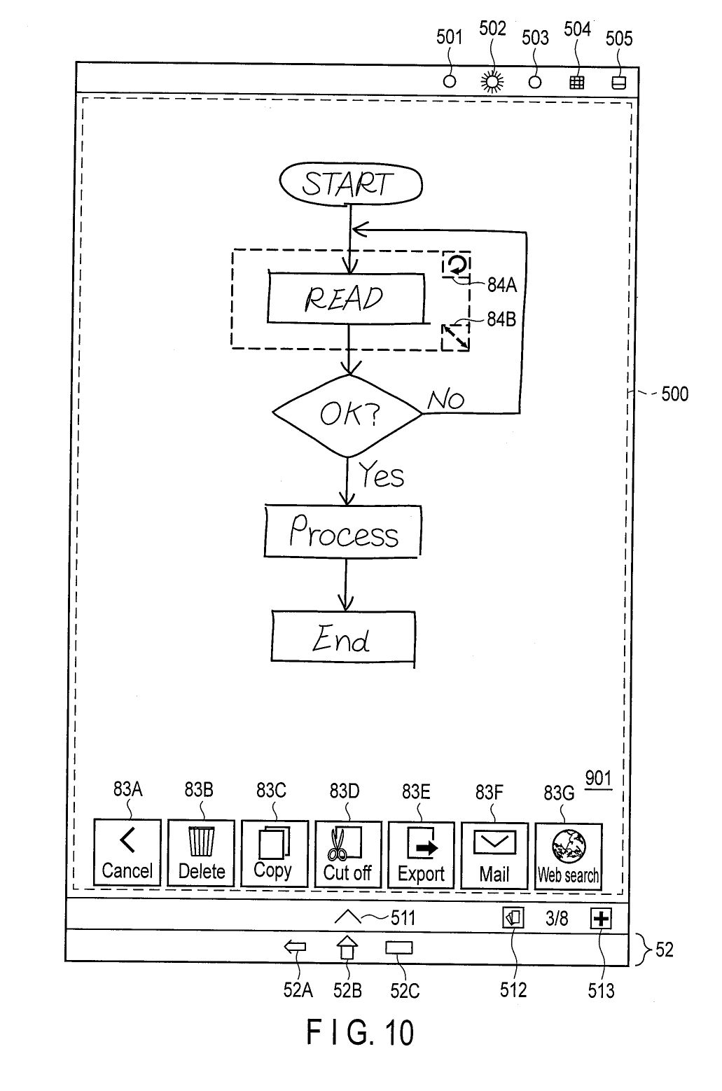

FIG. 10 shows a group of software buttons displayed as a menu on the page editing screen when a range selection operation using the stylus 100 has been performed on the page editing screen with the range selection stylus 504 selected by a user's tapping gesture using the stylus 100 or a finger.

When the range selection operation has been performed, a menu including a cancel button 83A, a delete button 83B, a copy button 83C, a cut-off button 83D, an export button 83E, a mail button 83F and a web search button 83G is displayed on the page editing screen as shown in FIG. 10. Further, when the range selection operation has been performed, a rotation button 84A and an enlargement (contraction) button 84B are displayed within a selected range (enclosed by a rectangular frame) as shown in FIG. 10.

The cancel button 83A is used to cancel the selected state. The delete button 83B is used to delete a stroke included in a selected range. The copy button 83C is used to copy a stroke included in a selected range. The cut-off button 83D is used to cut off a stroke included in a selected range. The export button 83E is used to display a submenu for export. The mail button 83F is used to activate processing of converting, into text, a handwritten page included in a selected range and sending the text via email. The web search button 83G is used to activate processing of converting, into text, a handwritten page included in a selected range and performing web searching.

The rotation button 84A is used to clockwise or counterclockwise rotate a handwritten page included in a selected range. The enlargement (contraction) button 84B is used to enlarge or contract a handwritten page included in a selected range.

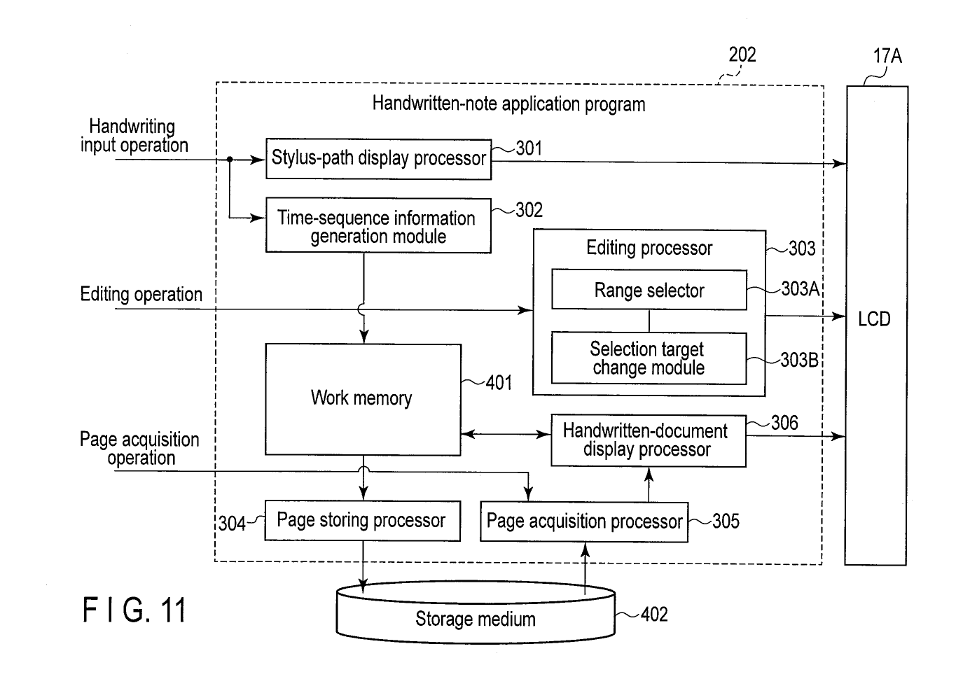

Referring then to FIG. 11, a description will be given of the function structure of the handwritten-note application program 202.

The handwritten-note application program 202 includes a stylus-path display processor 301, a time-sequence information generation module 302, an editing processor 303, a page storing processor 304, a page acquisition processor 305, a handwritten-document display processor 306, a work memory 401, etc. The editing processor 303 includes a range selector (first display controller) 303A and a selection target change module (second display controller) 303B.

The handwritten-note application program 202 performs, for example, creation, display and editing of a handwritten document, using stroke data input through the touch screen display 17. The touch screen display 17 is configured to detect events, such as “touch,” “slide” and “release.” “Touch” is an event indicating that an external object has touched the screen. “Slide” is an event indicating that a touch position moves while the external object gets in touch with the screen. “Release” is an event indicating that the external object is detached from the screen.

The stylus-path display processor 301 and the time-sequence information generation module 302 receive the “touch” or “slide” event from the touch screen display 17 to thereby detect a handwriting input operation. The “touch” event includes the coordinates of a touch position. The “slide” event includes the coordinates of a destination touch position. Thus, the stylus-path display processor 301 and the time-sequence information generation module 302 receive, from the touch screen display 17, a coordinate sequence corresponding to the path along which the touch position has moved.

The stylus-path display processor 301 receives the coordinate sequence from the touch screen display 17, thereby displaying, on the screen of the LCD 17A of the touch screen display 17, the path of each stroke handwritten by a handwriting input operation using, for example, the stylus 100, based on the coordinate sequence. By the stylus-path display processor 301, the path of the stylus 100 made during the time when the stylus 100 touches the screen, i.e., the path of each stroke, is drawn on the screen of the LCD 17A.

The time-sequence information generation module 302 receives the above-mentioned coordinate sequence from the touch screen display 17, thereby generating, based on the coordinate sequence, the above-described time-sequence information having such a structure as described in detail referring to FIG. 4. At this time, the time-sequence information, i.e., the coordinates and the timestamp information corresponding to each point of a stroke, may be temporarily stored in the work memory 401.

The editing processor 303 performs processing of editing a handwritten page currently displayed. Namely, the editing processor 303 performs editing processing for deleting, moving, or the like, at least one of a plurality of currently displayed strokes in accordance with a user's editing operation on the touch screen display 17. Further, the editing processor 303 updates currently displayed time-sequence information to reflect the result of the editing processing.

The range selector 303A performs range selection processing of selecting one or more strokes (first stroke(s)) within a selected first range from the currently displayed strokes in accordance with a first operation (range selection operation) of selecting the first range performed by the user on the touch screen display 17. The one or more strokes selected by the range selection processing are entirely included in the range selected by the range selection operation. Alternatively, the stroke, at least part of which or at least a certain ratio of which is included in the range selected by the range selection operation, may also be selected by the range selection processing. The one or more strokes selected by the range selection processing are displayed on the LCD 17A so that they can be discriminated as selected targets from the other strokes by, for example, their colors or degrees of transparency.

The selection target change module 303B performs selection target change processing of changing a selection target, if one or more strokes within the first range selected by the first operation are set as the selection targets, and if a second operation of sequentially selecting a second range is performed by the user. For instance, after the first operation of selecting the first range, the user performs the second operation of selecting the second range while pressing the side button of the stylus 100. By thus pressing the side button of the stylus 100 after the first operation, the selection target change module 303B can detect that the first and second operations should be performed sequentially.

Referring now to FIGS. 12 to 18, the selection target change processing will be described in detail.

FIG. 12 shows one or more strokes selected by the range selection processing. In FIG. 12, the strokes (of thick lines) included in the first range selected by the first operation, i.e., strokes SD101 to SD105 constituting handwritten characters “R” and “E,” are selection targets.

FIG. 13 is a view for explaining selection target change processing performed when the first and second ranges do not overlap each other. As shown in FIG. 13, when the first and second ranges do not overlap each other, the selection target change module 303B changes the selection targets by maintaining the selection of the one or more strokes in the first range, and also selecting one or more strokes (second stroke(s)) in the second range. Namely, the strokes SD101 to SD105 constituting the handwritten characters “R” and “E” included in the first range, and the strokes SD106 to SD109 constituting the handwritten characters “A” and “D” included in the second range, are regarded as selection targets.

FIG. 14 is a view for explaining selection target change processing performed when the first range is greater than the second range and includes the second range. As shown in FIG. 14, when the first range is greater than the second range and includes the second range, the selection target change module 303B changes selection targets by excluding, from the selection targets, one or more strokes included in the overlapping range, and maintaining the selection of one or more strokes included in the first range only. Namely, the strokes SD103 to SD105 constituting the handwritten character “E” included in the overlapping range are excluded from the selection targets, and the strokes SD101 and SD102 constituting the handwritten character “R” included in the first range only are regarded as the selection targets.

FIG. 15 is a view for explaining selection target change processing performed when the second range is greater than the first range and includes the first range. As shown in FIG. 15, when the second range is greater than the first range and includes the first range, the selection target change module 303B changes selection targets by excluding, from the selection targets, one or more strokes included in the overlapping range, and maintaining the non-selection of one or more strokes included in the second range only. Namely, the strokes SD101 to SD105 constituting the handwritten characters “R” and “E” included in the overlapping range are excluded from the selection targets, and the strokes SD106 to SD109 constituting handwritten characters “A” and “D” included in the second range only are not selected. Thus, all strokes are excluded from the selection targets.

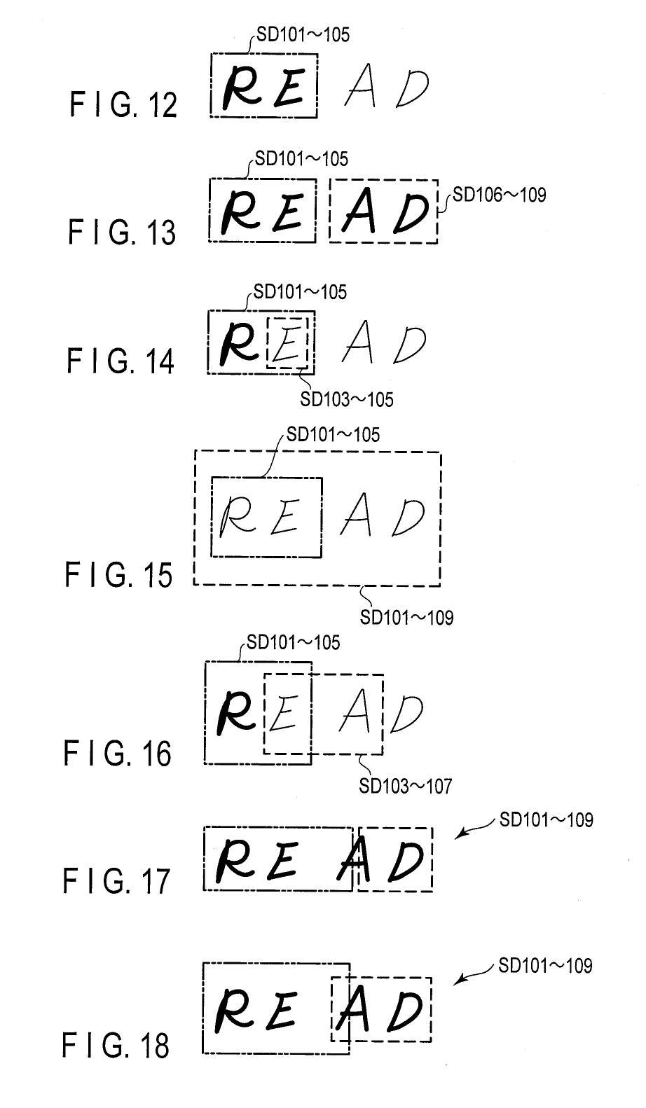

FIG. 16 is a view for explaining selection target change processing performed when the first and second ranges partially overlap each other. As shown in FIG. 16, when the first and second ranges partially overlap each other, the selection target change module 303B changes selection targets by excluding, from the selection targets, one or more strokes included in the overlapping range, maintaining the selection of one or more strokes included in the first range only, and also excluding, from the selection targets, one or more strokes included in the second range only. Namely, the strokes SD103 to SD105 constituting the handwritten character “E” included in the overlapping range are excluded from the selection targets, the strokes SD101 and SD102 constituting the handwritten character “R” included in the first range only are maintained as the selection targets, and the strokes SD106 and SD107 constituting the handwritten character “A” included in the second range only are not selected. Thus, just the strokes SD101 and SD102 are regarded as the selection targets.

FIG. 17 is a view for explaining selection target change processing performed when the first and second ranges do not overlap each other, but when parts of strokes constituting a predetermined handwritten character are included in the first and second ranges. In the case of FIG. 17, firstly, the selection target change module 303B maintains the selection of one or more strokes included in the first range only, and selects one or more strokes included in the second range only. After that, if the most part of the strokes constituting a predetermined handwritten character consists of one or more strokes that are partially included in the overlapping portion of the first and second ranges, the selection target change module 303B selects the one or more strokes. In contrast, if the most part of the strokes does not consist of the mentioned one or more strokes, the selection target change module 303B does not select the one or more strokes. Namely, the strokes SD101 to SD105 constituting the handwritten characters “R” and “E” included in the first range only, the strokes SD108 and SD109 constituting the handwritten character “D” included in the second range only, and the strokes SD106 and SD107 constituting the handwritten character “A” whose greater parts are included in the overlapping portion of the first and second ranges, i.e., all strokes SD101 to SD109, are regarded as selection targets.

FIG. 18 is a view for explaining selection target change processing performed when the first and second ranges partially overlap each other, when strokes constituting a predetermined handwritten character are included in the overlapping portion of the first and second ranges, and when part of strokes constituting a predetermined handwritten character is included in the first range, and all strokes constituting predetermined characters are included in the second range. In the case of FIG. 18, firstly, the selection target change module 303B maintains the selection of one or more strokes included in the first range only, and selects one or more strokes included in the second range only. After that, if part of one or more strokes constituting a predetermined handwritten character included in the first range occupies the most part of the one or more strokes constituting the handwritten character (i.e., if the first and second ranges partially overlap each other and the degree of overlapping is greater than a threshold value), the selection target change module 303B excludes the one or more strokes from the selection targets. In contrast, if the part does not occupy the most part (i.e., if the first and second ranges partially overlap each other and the degree of overlapping is less than the threshold value), the selection target change module 303B determines that the one or more strokes are included in the second range only, and selects them. Thus, selection target change is performed. Namely, the strokes SD101 to SD105 constituting the handwritten characters “R” and “E” included in the first range only, the strokes SD108 and SD109 constituting the handwritten character “D” included in the second range only, and the strokes SD106 and SD107 constituting the handwritten character “A” determined as mentioned above to be included in the second range only, i.e., all strokes SD101 to SD109, are regarded as selection targets.

As described above, the selection target change module 303B can change selection targets arbitrarily.

The page storing processor 304 stores generated time-sequence information as a handwritten document (handwritten page) in a storage medium 402. The storage medium 402 may be a storage device in the tablet computer 10 or the personal computer 1, or the storage device 2A of the server 2 as described above.

The page acquisition processor 305 reads arbitrary already stored time-sequence information from the storage medium 402. The read time-sequence information is sent to the handwritten-document display processor 306. The handwritten-document display processor 306 analyzes the time-sequence information, and displays, on the screen as a handwritten page, the path of each stroke indicated by the analyzed time-sequence information.

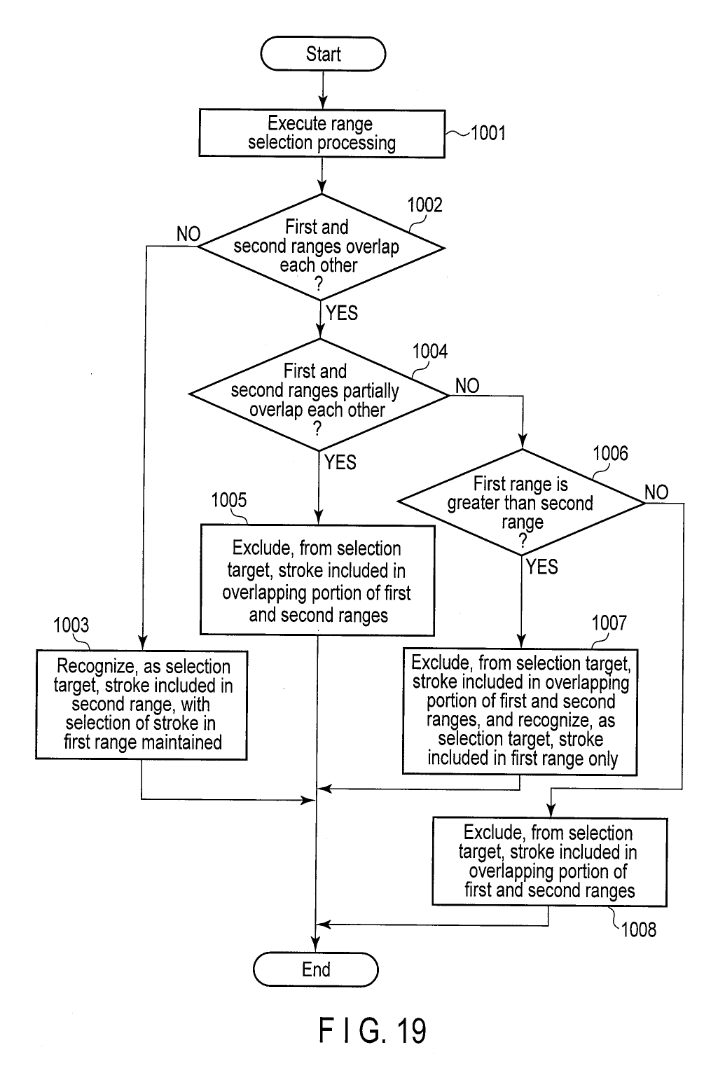

Referring then to FIG. 19, a description will be given of an editing procedure by the editing processor 303 of the handwritten-note application program 202. Specifically, range selection processing and selection target change processing will be mainly described.

Firstly, the range selector 303A of the editing processor 303 performs range selection processing in accordance with the first operation for selecting the first range (block 1001). By this range selection processing, the handwritten-note application program 202 can recognize, as selection targets, one or more strokes included in the first range selected by the first operation.

Subsequently, the selection target change module 303B in the editing processor 303 determines whether the first and second ranges overlap each other, in accordance with the second operation performed subsequent to the first operation to select the second range (block 1002).

If it is determined that the first and second ranges do not overlap each other (No in block 1002), the selection target change module 303B recognizes, as new selection targets, one or more strokes included in the second range, with the one or more strokes in the first range maintained as the selection targets (block 1003), thereby terminating the editing processing.

In contrast, if it is determined that the first and second ranges overlap each other (Yes in block 1002), the selection target change module 303B determines whether the first and second ranges partially overlap each other (block 1004).

If it is determined that the first and second ranges partially overlap each other (Yes in block 1004), the selection target change module 303B excludes, from the selection targets, one or more strokes included in the overlapping portion of the first and second ranges, and recognizes, as the selection targets, one or more strokes included in the first range only (block 1005), thereby terminating the editing processing.

In contrast, if it is determined that the first and second ranges do not partially overlap each other, i.e., that the first and second ranges completely overlap each other (No in block 1004), the selection target change module 303B determines whether the first range is greater than the second range (block 1006).

If it is determined that the first range is greater than the second range (Yes in block 1006), the selection target change module 303B excludes, from the selection targets, one or more strokes included in the overlapping portion of the first and second ranges, and recognizes, as the selection targets, one or more strokes included in the first range only (block 1007), thereby terminating the editing processing.

In contrast, if it is determined that the first range is not greater than the second range, i.e., the second range is greater than the first range (No in block 1006), the selection target change module 303B excludes, from the selection targets, one or more strokes included in the overlapping portion of the first and second ranges, i.e., the selection target change module 303B regards none of the strokes as a selection target (block 1008), thereby terminating the editing processing.

According to the above-described embodiment, the tablet computer 10 employs the handwritten-note application program 202, in which the second range is selected by the second operation immediately after each stroke included in the first range selected by the first operation is set as a selection target (editing target), whereby selection target change can be performed without re-executing the first operation. Therefore, it is not necessary to re-select an editing target from the beginning by re-executing the range selection operation, which is much convenient to the user.

Further, since each processing in the embodiment can be realized by a computer program, the same advantage as that of the embodiment can be obtained simply by installing the computer program into a standard computer through a computer-readable storage medium storing this program, and executing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display controller configured to
display first strokes as selection targets in accordance with a first operation for selecting a first range comprising the first strokes in a handwritten document, and
display a second range selected by a second operation, if the second operation is performed during displaying the first strokes as the selection targets, wherein the second range comprises either one or more strokes in the first strokes to be excluded from the selection targets, or one or more strokes other than the first strokes to be added to the selection targets,
wherein a display form of one or more strokes in the selection targets differs from a display form of one or more strokes that are not in the selection targets.

2. The electronic device of claim 1, wherein when the first and second ranges do not overlap each other, the selection targets comprise the first strokes and one or more second strokes selected in the second range.

3. The electronic device of claim 1, wherein when the first range includes the second range, the selection targets comprise strokes obtained by excluding, from the first strokes, one or more second strokes selected in the second range.

4. The electronic device of claim 1, wherein
when the first and second ranges partially overlap each other, the selection targets comprise strokes obtained by excluding, from the first strokes, one or more second strokes selected in the second range; and
when the one or more second strokes are not in the first strokes, the one or more second strokes are not in the selection targets.

5. The electronic device of claim 4, wherein when the first and second ranges partially overlap each other and a degree of overlapping is lower than a threshold value, the selection targets comprise both the first strokes and the one or more second strokes.

6. A method comprising:
displaying a first strokes as selection targets in accordance with a first operation for selecting a first range comprising the first strokes in a handwritten document, and
displaying a second range selected by a second operation, if the second operation is performed during displaying the first strokes as the selection targets, wherein the second range comprises either one or more strokes in the first strokes to be excluded from the selection targets, or one or more strokes other than the first strokes to be added to the selection targets,
wherein a display form of one or more strokes in the selection targets differs from a display form of one or more strokes that are not in the selection targets.

7. The method of claim 6, wherein when the first and second ranges do not overlap each other, the selection targets comprise the first strokes and one or more second strokes selected in the second range.

8. The method of claim 6, wherein when the first range includes the second range, the selection targets comprise strokes obtained by excluding, from the first strokes, one or more second strokes selected in the second range.

9. The method of claim 6, wherein
when the first and second ranges partially overlap each other, the selection targets comprise strokes obtained by excluding, from the first strokes, one or more second strokes selected in the second range; and
when the one or more second strokes are not in the first strokes, the one or more second strokes are not in the selection targets.

10. The method of claim 9, wherein when the first and second ranges partially overlap each other and a degree of overlapping is lower than a threshold value, the selection targets comprise both the first strokes and the one or more second strokes.

11. A non-transitory computer-readable storage medium storing computer-executable instructions that, when executed, cause a computer to:
display a first strokes as selection targets in accordance with a first operation for selecting a first range comprising the first strokes in a handwritten document, and
display a second range selected by a second operation, if the second operation is performed during displaying the first strokes as the selection targets, wherein the second range comprises either one or more strokes in the first strokes to be excluded from the selection targets, or one or more strokes other than the first strokes to be added to the selection targets,
wherein a display form of one or more strokes in the selection targets differs from a display form of one or more strokes that are not in the selection targets.

12. The storage medium of claim 11, wherein when the first and second ranges do not overlap each other, the instructions cause the computer to include, in the selection targets, the first strokes and one or more second strokes selected in the second range.

13. The storage medium of claim 11, wherein when the first range includes the second range, the instructions cause the computer to include, in the selection targets, strokes obtained by excluding, from the first strokes, one or more second strokes selected in the second range.

14. The storage medium of claim 11, wherein
when the first and second ranges partially overlap each other, the instructions cause the computer to include, in the selection targets, strokes obtained by excluding, from the first strokes, one or more second strokes selected in the second range; and
when the one or more second strokes are not in the first strokes, the instructions cause the computer to exclude, from the selection targets, the one or more second strokes.

15. The storage medium of claim 14, wherein when the first and second ranges partially overlap each other and a degree of overlapping is lower than a threshold value, the instructions cause the computer to include, in the selection targets, both the first strokes and the one or more second strokes.
